(19) United States
(12) Patent Application Publication
(10) Pub. No.: US 2023/0180797 A1
(43) Pub. Date: Jun. 15, 2023

(54) SOLID-STATE MICROWAVE STERILIZATION AND PASTEURIZATION

(71) Applicant: WASHINGTON STATE UNIVERSITY, Pullman, WA (US)

(72) Inventors: Juming TANG, PULLMAN, WA (US); Franklin Loring YOUNCE, PULLMAN, WA (US); Zhongwei TANG, Pullman, WA (US); Fang LIU, PULLMAN, WA (US)

(21) Appl. No.: 17/999,268

(22) PCT Filed: May 20, 2021
(86) PCT No.: PCT/US2021/033298

§ 371 Date: Nov. 18, 2022

Related U.S. Application Data
(60) Provisional application No. 63/027,782, filed on May 20, 2020.

(51) Int. Cl. A23L 3/01; A23L 3/015; A23L 3/02; H05B 6/68; H05B 6/70; H05B 6/78; H05B 6/80

(52) U.S. Cl. CPC A23L 3/01; A23L 3/02; A23L 3/0155; H05B 6/80; H05B 6/686; H05B 6/701; H05B 6/705; H05B 6/782; H05B 2206/045

(57) ABSTRACT

Method and apparatus for industrial microwave (MW)-assisted thermal sterilization and pasteurization using solid-state MW generators. One or more phased array generators heat packaged foods or liquids conveyed in transport carriers through a processing liquid providing supplemental temperature control and hydrostatic pressure. Generator output signals are computer controlled, allowing phase and power-ratio modulation to both adjust interference patterns within heating cavities and shift focus of heating energy.

### STATEMENT REGARDING FEDERALLY SPONSORED RESEARCH

The present invention was made with government support under grant number 2016-68003-24840 awarded by the United States Department of Agriculture, through the National Institute of Food and Agriculture. The government has certain rights in the invention.

### FIELD OF THE INVENTION

This disclosure relates to continuous flow packaged food processing, specifically microwave (MW)-assisted thermal sterilization and pasteurization using solid-state (SS) MW generators.

### BACKGROUND

Microwaves (MWs) are electromagnetic waves at frequencies between 300 MHz and 300 GHz. In the mid-1900s, MW heating was introduced for food processing. Industrial-scale MW-assisted thermal sterilization and pasteurization systems offer several benefits over alternative heating methods such as retort processing, including improved flavor, texture, and nutrition due to shorter processing time. Despite advantages, uneven heating has been a continued challenge in MW systems of all sizes, addressed through various schemes, including moving food products relative to MW interference patterns within heating chambers, supplementing MW heating, shielding edges prone to overheating, incorporating splitters within waveguide assemblies to direct energy from multiple directions, and using multiple generators and MW horns to heat food products from multiple sides.

Industrial MW heating systems for food applications have thus far relied on magnetrons to generate sufficient MW heating energy. A typical magnetron consists of a cathode, an anode, magnets for a static magnetic field, and an output antenna. Magnetrons produce consumable single frequency components with a limited lifespan and tendency to degrade in performance over time. The frequency (f) of the MW produced by the magnetron is defined by:

$$f \approx \frac{1}{2 π} \sqrt{\frac{1}{L C}}$$

where L is the equivalent inductance and C is the equivalent capacitance of anode cavities. L and C are determined by the cavities’ physical dimensions. Therefore, the MW frequency is determined entirely by the dimensions of the anode cavities in the magnetron. The larger size the magnetron with larger L and C, the lower frequency of MWs could be obtained. The magnetron for 915 MHz is, thus, much larger than that for 2450 MHz. Magnetrons operating at 915 MHz are available up to 100 kW, while those operating at 2450 MHz are typically designed for about 1 kW. Capacity to adjust output signal characteristics is limited, and designs to apply MW energy from multiple directions to a heating chamber are dependent on waveguide geometry. Fixed waveguide designs cannot be easily fine-tuned to calibrate for magnetron variance and optimize MW interference nodes. Variable geometry waveguides, such as those with telescoping “trombone” slide mechanisms, add undesirable mechanical complexity.

Solid-state (SS) MW generators provide an alternative MW source with longer life and more easily adjustable output waveforms. Because magnetrons are heavy, vibration-sensitive, and operate at high-voltage, SS generators are especially attractive for small or portable systems. SS generators have mostly been scaled to provide output power comparable to kitchen ovens, on the order of 1 kW or less. Such generators are usually phased arrays of lower-powered transmitter elements manufactured using traditional semiconductor fabrication processes, so scaling them beyond kitchen applications has been limited in part by existing tooling and temperature sensitivity of electronic components.

### SUMMARY

Presented here are methods and apparatuses incorporating SS MW generators for industrial pasteurization or sterilization of pre-packaged food products and other items having a water content, combining dielectric and surface heating within an immersion liquid.

In an example embodiment, transport carriers securely hold multiple sealed food packages throughout processing and are configured to permit MW intrusion as well as rapid flooding and draining. The transport carriers are loaded into and conveyed through the processing apparatus, starting with a tray loader assembly which submerges carriers in temperature-controlled water circulated within a preheating zone. Transport carriers are then conveyed into a heating zone by passing through a portal which limits inter-zone mixing of the water by use of e.g. flexible flaps.

As the transport carriers continue through the heating zone subject to the water’s hydrostatic pressure or overpressure in pressurized vessels, they pass multiple heating cavities fed from synchronized top and bottom SS MW phased array generators, modulated in phase, amplitude, and frequency to provide desired (e.g., predetermined, specific) heating patterns and/or uniformity of MW penetration into the food product. Water is circulated and temperature controlled within the MW heating and connected holding zone, which is designed to stabilize and maintain temperature for a time appropriate to the sterilization or pasteurization purpose, as well as the heating characteristics of the product and portion size being processed. Transport carriers then pass through a second portal which inhibits liquid mixing between the holding zone and a follow-on cooling zone.

Water is circulated and temperature controlled within the cooling zone, which is sized and timed for the food product to reach a desired post-processing temperature. Transport carriers are then conveyed through the cooling zone and lifted by an unloading assembly out of the water, which freely drains from the transport carriers back into the cooling zone.

In some exemplary embodiments, SS MW generators are computer controlled, enabling two primary functions to account for desired treatment of various food products. First, top and bottom generators are controlled in matched pairs to ensure even heating and optimization of MW interference nodes. This function is accomplished by adjusting the power ratio and/or phase difference between opposing arrays. This effectively shifts the horizontal plane of maximum MW heating intensity. The shifting may occur dynamically if desired. Second, phased arrays allow for steering and sweeping energy laterally across and along the path food is conveyed. This is accomplished by changing the phase difference between individual transmitter elements within each array and allows either beam-steering to a fixed angle or dynamic sweeping.

System components can include a variety of materials and configurations, though wide-bandgap semiconductors such as gallium nitride (GaN), silicon carbide (SiC), and boron nitride (BN) allow SS MW generators to operate at higher voltage and temperature than standard silicon devices. In addition to the synchronization and beam-forming functions described above, frequency shifting helps counter the constructive and destructive interference patterns which contribute to uneven heating within a resonant cavity. Where magnetron-based designs must be sensitive to standing waves within a single-mode cavity, solid-state MW generators allow both a fixed center frequency mode as well as agile frequency shifting within a band. Frequency shifting reduces both the persistence and impact of standing waves.

Exemplary embodiments disclosed herein improve upon the inventors’ earlier work described in US 2016/0029685 A1, published 04-Feb-2016, the complete contents of which are herein incorporated by reference.

The incorporation of solid-state (SS) MW sources into embodiments herein yields a number of benefits over magnetron based systems, including higher reliability with longer lifespan, smaller size and lower operating voltages, easier replacement in the event of failure, higher stability and accuracy of the peak frequency, and effective phase control.

Magnetrons have relatively short lifetimes, about 500 h on average for domestic MW ovens, and one year of use in commercial and industrial continuous operations. The power output and peak frequency of a magnetron varies with temperature and with age. There is a need for regular power calibration and replacement of magnetrons, resulting in downtimes in industrial operations. SS generators, on the other hand, can operate for at least 15 years with consistent performance. The power output of SS generators is much more stable, eliminating the need for regular calibration and replacement of MW power sources.

The driving voltages for magnetrons can be very high (4-20 kV). Magnetrons and magnetron-based generators for lower frequency (e.g., 915 MHz) are bulky. By contrast, SS power amplifiers operate at lower voltages (50 V or less), and the generator systems have much smaller size and weight. They are quieter in operation and cost less to maintain. Smaller generators take less plant space.

Multiple SS generators can be used for precise delivery of MW power in an industrial system. In operation, each generator can be controlled independently, and/or the multiple generators can be synchronized together. High power SS generators can also be built by combining several smaller power modules. In case of power failure, it only takes minutes to replace a module or a SS generator with back-up units in storage, as they are much less expensive and take less storage space compared with that of high power 915-MHz generators based on magnetrons. This difference sharply reduces equipment maintenance cost and shortens down time of the production line in food plants.

The peak frequency of a magnetron is influenced by many factors such as aging & power setting of the magnetron, output impedance and load-dependent power reflection, and temperature-induced geometry dilations. SS power amplifiers have excellent spectral stability and the peak frequency is not influenced by the power setting or aging.

Magnetrons are uncontrolled oscillators, without the function of phase control or adjustment. In contrast the phases of SS generators can be synchronized and independently controlled. When the multiple SS MW power sources are supplied to an applicator cavity, the waves controlled with different phases can be displaced in time or space which can improve the uniformity of the electric fields, resulting in more uniform heating of the food.

### BRIEF DESCRIPTION OF THE DRAWINGS

FIG. 1A shows a block diagram of an exemplary SS MW generator unit.

FIG. 1B shows an NPN-type amplifying transistor of a SS MW generator.

FIG. 1C shows the basic circuit configuration for an NPN-type amplifying transistor of a SS MW generator.

FIG. 2A shows a pair of SS MW generators coupled to a heating chamber on a section of a food production line, with the generators positioned to provide energy to the top and bottom of food packages conveyed through from left to right.

FIG. 2B shows four generators ringing the line, with food packages conveyed into the diagram.

FIG. 2C shows a six generator ring with curved arrays.

FIG. 2D shows an example section of food production line with four pairs of SS MW generators.

FIG. 3A shows a side view of an example transport carrier containing food packages.

FIG. 3B shows the top view of top and bottom plates on the transport carrier.

FIG. 4 shows an example heating assembly with tray loader, water bath preheater, MW heating zone, holding zone, cooling zone, and tray unloading stack.

FIG. 5 shows example configurations of SS MW generator phased arrays.

FIG. 6A illustrates phased array beamforming, showing a side view of an example array;

FIG. 6B shows a curved phased array with natural focal point.

FIG. 7A shows beamforming capacity along the processing line.

FIG. 7B shows beamforming laterally from the processing line centerline.

FIG. 7C shows arrangement of a single MW array offset from the processing line centerline.

FIG. 8A shows a top view of a section of processing line with food transport carrier approaching a MW array which can be swept both along and across the line.

FIG. 8B illustrates an example progressive scan.

FIG. 9A illustrates preferential heating and sweeping schemes for food packages with layered contents of heterogeneous heating characteristics.

FIG. 9B illustrates preferential heating and sweeping schemes for food packages with contents of heterogeneous heating characteristics in laterally separate sections.

FIG. 10 illustrates a MW power calibration/testing system.

FIG. 11A is simulation results of electric field intensity along the depth of the MW heating cavity shown in FIG. 2A. Different patterns of standing waves are formed by the MWs supplied to the heating cavity from the top and bottom ports with three phase differences. The hot layers shown in red in FIG. 11A are the peaks of the standing waves depicted in FIG. 11B where MWs from top (right) and bottom (left) of the cavity.

FIG. 11B is a different illustration of the same information as in FIG. 11A, but with the graphs rotated from vertical to horizontal orientation for easy reading.

FIG. 12 shows principal steps of an exemplary computer-vision method for heating pattern detection.

### DETAILED DESCRIPTION

As used herein, the term “sterilization” generally refers to a process that eliminates or removes all forms of fungi, bacteria, viruses, spore forms, or other microbiological organisms present in food products that may produce toxins and/or cause spoilage of the products when stored at ambient temperature. Generally, “sterilization” for purposes of this disclosure refers to “commercial sterility” as that term is understood in the context of food for human consumption regulated by the Food and Drug Administration (FDA). “Commercial sterility” is defined by the FDA as follows (21 CFR 113): “Commercial sterility” of thermally processed food means the condition achieved (i) By the application of heat which renders the food free of (a) Microorganisms capable of reproducing in the food under normal nonrefrigerated conditions of storage and distribution; and (b) Viable microorganisms (including spores) of public health significance; or (ii) By the control of water activity and the application of heat, which renders the food free of microorganisms capable of reproducing in the food under normal nonrefrigerated conditions of storage and distribution. “Commercial sterility” is also defined by the FDA as follows (21 CFR 113): “Commercial sterility” of equipment and containers used for aseptic processing and packaging of food means the condition achieved by application of heat, chemical sterilant(s), or other appropriate treatment that renders the equipment and containers free of viable microorganisms having public health significance, as well as microorganisms of nonhealth significance, capable of reproducing in the food under normal nonrefrigerated conditions of storage and distribution. Exemplary embodiments disclosed herein are configured such that commercial sterilization is achievable or achieved.

Also used herein, the term “pasteurization” generally refers to a partial sterilization process in which microbiological organisms are partially but not completely eliminated or removed. The term “item” generally refers to any suitable article of manufacture that may be sterilized or pasteurized. Example items include, without limitation, food products, medical supplies, consumer products, and/or other suitable articles. Food items also include packages containing heterogeneous food products in layers or separate cavities, such as shaped trays capable of holding distinct portions of a meal. For convenience of discussion, “food package” is frequently used herein for describing exemplary embodiments, but it should be understood that such descriptions are applicable to any item(s). The term “food product” generally refers to any food items suitable for human or animal consumption. Examples of a food product include, without limitation, packaged foods, canned foods, dairy products, beer, syrups, water, wines, and juices.

Sterilization or pasteurization by heating food products with hot air, hot water, or steam may result in poor taste, texture, color, smell, or other adverse effects. During the heating process, a surface or exterior portion of the food products may be excessively heated in order to achieve a desired interior temperature. Such excessive heating is one factor that may cause the foregoing adverse effects in the food products. Several embodiments of the disclosed technology utilize MW to heat items (e.g., a food product) immersed in an immersion liquid (e.g., tempered water) to sterilize or pasteurize the items. As discussed in more detail below, several embodiments of the disclosed technology require less processing time than conventional techniques, and can produce repeatable and generally uniform temperature profiles in the items to achieve sterilization or pasteurization in an efficient and cost-effective manner.

To avoid interference with the telecommunication industry, a limited number of frequency bands are allocated by the US Federal Communications Commission (FCC) for industrial, scientific, and medical (ISM) applications. Two of those frequencies are commonly used for heating applications. 2450 ±50 MHz (wavelength in air, 0.122 m) is used in domestic MW ovens and industrial systems, whereas 915 ±13 MHz (wavelength in air, 0.327 m) is primarily used in industrial heating systems. One important consideration in selecting an appropriate MW frequency for food processing is the penetration depth of MW energy in food. The penetration depth (dp, m) is defined as the depth where the MW power intensity decays to 36.8% of the initial strength. It is a key factor that influences heating uniformity and in selecting the thickness of food for MW heating. The penetration depth may be calculated by:

$${d}_{p} = \frac{c}{2 π f \sqrt{2 ∈ ′ \left[\sqrt{1 + \left(\frac{∈ ″}{∈ ′}\right) - 1}\right]}}$$

where c is the speed of light in free space (3 × 10⁸ m/s), f is MW frequency in Hz, and ε′ and ε′′ are the relative dielectric constant and loss factor of a food material. MW power penetration depths in foods and water are larger at lower frequencies as illustrated in Table 1. For example, the penetration depths in salmon fillets and cooked macaroni noodles at 915 MHz are 1.7 ~ 2.5 times those at 2450 MHz; the penetration depths in tap water and reverse osmosis (RO) water at 915 MHz are 2.3 and 4.8 times those at 2450 MHz, respectively.

TABLE 1

MW power penetration depths (dₚ, mm) in foods and water at different frequencies.

| T (°C) | Salmon Fillets (middle section, 1.7% fat, 75.0% moisture) | | Cooked Macaroni Noodles (56.3% moisture) | | Tap Water | | Reverse Osmosis (RO) Water | |
|---|---|---|---|---|---|---|---|---|
| | 915 Mhz | 2450 MHz | 915 MHz | 2450 MHz | 915 MHz | 2450 MHz | 915 MHz | 2450 MHz |
| 20 | 17.6 | 8.9 | 67.3 | 17.0 | 107.0 | 18.0 | 131.0 | 19.0 |
| 80 | 9.8 | 6.8 | 63.2 | 28.1 | 148.0 | 61.0 | 369.0 | 63.0 |
| 120 | 7.0 | 4.9 | 51.1 | 28.1 | 122.0 | 86.0 | 457.0 | 117.0 |

Another important consideration for frequency selection is the heating pattern / cold spot predictability. To ensure microbial safety of the processed food, it is important that an industrial MW sterilization or pasteurization system heats food packages with a stable heating pattern so that the cold spot stays at a predictable location inside the food packages. Generally only a single-mode heating cavity can satisfy this requirement. The size of a single-mode cavity is proportional to the wavelength of MW. Specifically, a single-mode cavity for 915 MHz MW is about 3 times the size of one for 2450 MHz MW. All domestic ovens and industrial heating units at 2450-MHz are multi-mode cavities by design since 2450-MHz single-mode cavities are too small for heating foods in single-meal-sized packages. 915-MHz single-mode cavities are large enough to accommodate the food packages for MW sterilization or pasteurization.

### SS MW Generators

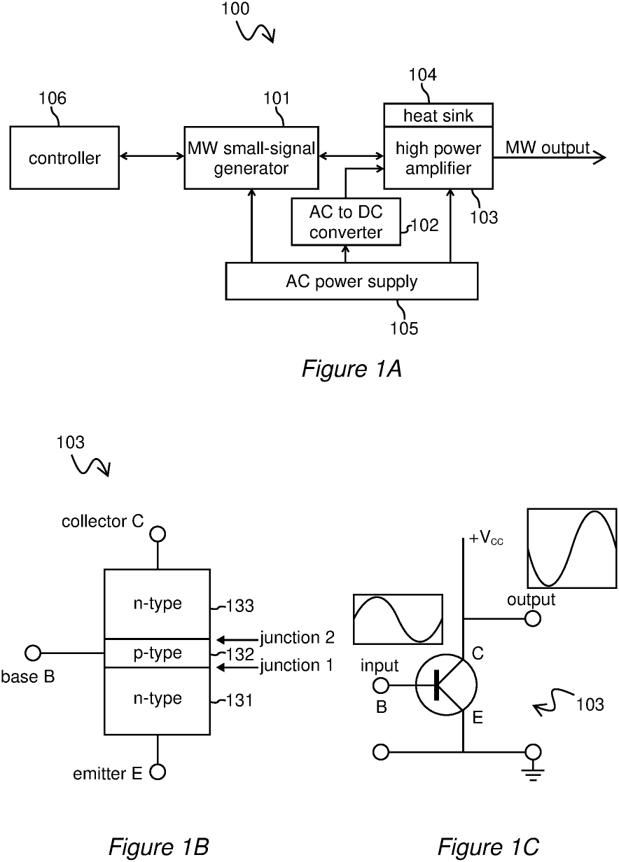

FIG. 1A shows an exemplary SS MW power generator 100 which comprises a small-signal generator 101, an AC to DC converter 102, a high-power amplifier 103, a heat sink 104, and an AC power supply 105. Included in the generator 100 or else attached thereto in a state of operation is a system controller 106. An exemplary controller 106 may be analog or digital. An exemplary controller 106 may be one or more processors, one or more microprocessors, and/or one or more computers. The high power amplifier 103 converts a small MW signal from MW small-signal generator 101 into high power MW energy, eliminating any need for a magnetron. Overall heating times for food packages to reach desired temperature are reduced in the SS MW heating system by over 30% compared to magnetron-based MW systems because of the improved heating uniformity. The reduced heating time leads to better product qualities.

FIG. 1B shows an exemplary high power amplifier 103, and FIG. 1C shows the same amplifier 103 in a basic circuit configuration. In this example, the amplifier 103 is composed of three semiconductor components which are joined with two junctions. The three semiconductor components are a p-type semiconductor layer 132 sandwiched between an n-type semiconductor layer 131 and another n-type semiconductor layer 133. Layers 131 and 132 form a first junction. Layers 132 and 133 form a second junction. Together the layers 131, 132, and 133 form a NPN-type transistor. While a small MW input is applied to the base B, both the small voltage and the small current flowing through the base are amplified to generate a large MW output. A SS generator can combine multiple basic power modules (e.g., 200-500 W each) made from amplifying transistors to reach various power levels (e.g., up to 10 kW) for efficient MW generation.

The capacity and reliability of the amplifying transistors is determined by the semi-conductor materials used in their construction. The semiconductor materials used for transistors may include one or more of Silicon (Si), Silicon Carbide (SiC), Silicon Germanium (SiGe), Laterally Diffused Metal-Oxide-Semiconductor (LDMOS), and Gallium Arsenide (GaAs). In some embodiments, a preferred material is Gallium Nitride (GaN). Generally, GaN-based transistors are capable of providing an output power many times higher than that of GaAs- or Si-based transistors. Generally, GaN-based transistors have better thermal conductivity, a higher switching speed (reaching 100V/ns), and a higher power conversion efficiency compared with Si-based transistors. GaN transistors can also work with higher current densities at higher temperatures.

Some GaN transistors may be sourced commercially and adapted for use in exemplary embodiments. RFHIC Corp. has developed and produced GaN-based generators with up to 20 kW for 2450-MHz applications and up to 30-kW for 915 MHz in communication applications. Crescend Technologies LLC (Schaumburg, IL), Wattsine Electronic Technology Corp. (Chengdu, China) and MKS Instruments, Inc (Andover, MA, USA) also have similar products on the market. However, none of these commercially available GaN transistors are specifically designed for direct use in food processing applications. They also require the further addition of an applicator cavity. Accordingly, additional modification and configurations are required for implementation in exemplary embodiments herein.

### Paired SS MW Generators and MW Cavities

SS MW generator arrays may be positioned individually at various locations along the food processing line, but one way to help achieve uniform and rapid heating is to heat food packages simultaneously from the top and bottom. At least one pair of opposed generators represents the basic heating unit in some exemplary embodiments. This effectively doubles the MW energy of a single generator within the same length of processing line resulting in less overall heating time. The paired arrangement also balances the effect of greater energy absorption on the side facing the MW source. Alternatives to the paired arrangement include both unpaired generators and sets of more than two generators oriented radially from the production line axis to form a ring of generators. Single generators can also be arranged along the processing line at various angles offset from the position centered directly above or below the line, such as in applications requiring asymmetrical heating. For instance, some packaged meals will include foods with different heating characteristics combined in more than one section of the packaging.

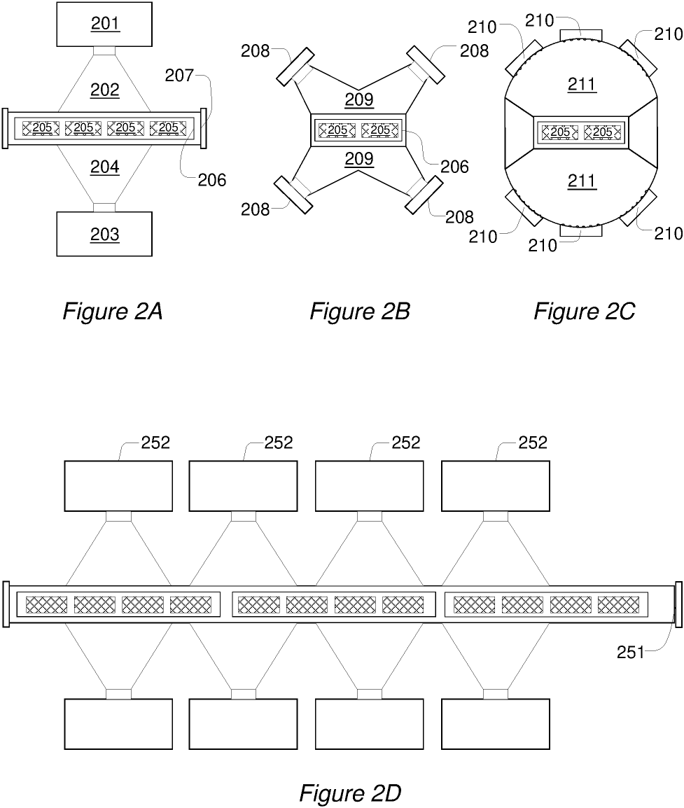

FIG. 2A presents (in a side cross section) an example pair of MW generators situated to heat food from opposing sides. A top SS MW generator 201 transmits MW energy downward into a cavity 202 above a section of the liquid-filled processing line 207. A bottom SS MW generator 203 transmits MW energy upward into a cavity 204 below the same section. Food packages 205 are contained in a transport carrier 206 and conveyed along the processing line through this MW heating zone. FIG. 2B shows an example ring arrangement (viewed in cross section along the direction of conveyance) of four SS MW generators 208 and combined MW cavities 209. FIG. 2C shows an example ring with curved array generators 210 with curved MW cavities 211.

In FIG. 2A, depending on desired performance, cavities 202 and 204 are configurable as single-mode cavities for a particular peak frequency. MW energy within heating cavities is subject to interference patterns, with destructive interference at nodes causing lower energy “cold spots”, and constructive interference at anti-nodes causing higher energy “hot spots”. To move and minimize adverse impact of interference patterns, SS MW generators are subject to computer control to optimize or change interference patterns over time. Alternatively, resonance of chambers is less important for applications in which frequency shifting and/or beam-forming are preferred, transport carriers in circulation water have low reflectivity, and the energy absorption by food products and immersion liquid is expected to quickly dampen reflected energy.

For efficiency and worker safety, materials forming MW cavities are selected to serve as effective Faraday shields and/or cages, except where MW energy is to be transmitted into the channel in which items are immersed and conveyed. Primary construction may be sheet metal for durability, though multiple alternative materials may be impregnated with a metal mesh or foil to serve the same purpose. Likewise, a transparent window with metal mesh can be situated to enable visual inspection and/or monitoring by an externally mounted infrared imaging device. Transmissive windows are also fitted where cavities join the housing containing the immersion liquid and items to be sterilized or pasteurized.

FIG. 2D shows an example section of food production line 251, with four pairs of MW generators 252 (each pair 252 equivalent to a basic pair 201/203 depicted in FIG. 2A) providing an extended MW heating zone through which food packages are conveyed. The number of MW generator subassemblies may be determined based in part on the cumulative heating energy required for a certain application, size of affordable generator arrays, and desired processing time, and through puts of the production line.

Some figures herein do not show subcomponents which would be known and understood in the food processing and electronics industries, such as connectors and computer controllers for the SS MW generators, modes of conveyance for the transport carriers, and circulation systems for the immersion liquid. Level portions of the food processing line can use several types of conveyance, such as paddle belts and/or water jets.

### Transport Carriers

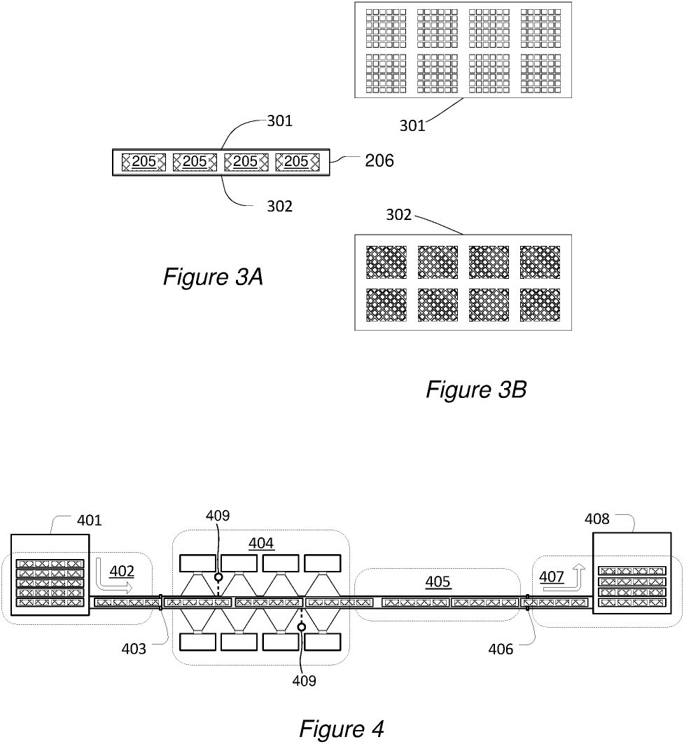

FIG. 3A provides a side cross section of an exemplary transport carrier 206 containing food packages 205. The transport carrier is an elongated box with top plate 301 and a bottom plate 302. FIG. 3B shows a top view of example top plate 301 and bottom plate 302 with grating designed to expose food products to MW energy while attenuating that energy and shielding edges of food packages.

Transport carriers can be sized and constructed of various materials based on need. In some applications, metal frames will provide durability, affordability in terms of service life, and shielding of parts (e.g., package edges) which would otherwise be prone to overheating. Alternatively, rigid plastics and fiber composite materials may be selected to allow for greater transmission of MW energy through the transport carrier and absorption in the food packages and immersion liquid. Where a shielding material is selected, grid patterns of top and bottom plates are selected to expose portions of carrier contents to MW energy.

Transport carriers may be configured as collapsible boxes or with fixed (e.g., welded) sides and bottom. They may include partial dividers to keep food packages in place during conveyance through processing equipment. The top plate may be fully removeable (e.g., slide mechanism), latchable (e.g., toggle latch), and/or openable (e.g., with hinges), to allow loading and unloading of food packages.

### Continuous Flow System With Multiple Temperature Control Zones

FIG. 4 shows a side view of an example heating assembly where transport carriers containing food packages (or other items) are conveyed left to right. First, a tray loader 401 lowers and immerses transport carriers into a temperature controlled circulating liquid. Transport carriers then proceed through a preheating zone 402 before crossing through a first portal 403 which inhibits mixing between temperature zones. The MW heating zone 404 (equivalent to section depicted in FIG. 2D) connects to a holding zone 405. A second portal 406 leads to a cooling zone 407 and unloading stack 408. This configuration adds efficiency for the industrial context in comparison to kitchen-style MW ovens where food is both loaded and removed through a single door.

Feedback controls using infrared, radio frequency (RF), or other sensors 409 may be included to drive actual MW outputs toward a desired result, even as items are being actively moved through the continuous flow system. For illustrative purposes two sensors 409 are shown in FIG. 4 within the heating zone 404, though sensors 409 may in various embodiments be positioned in fewer or greater number and in any of the zones of the system. The sensors 409 may monitor e.g. temperatures and heating patterns in items and supply feedback to the controller(s) (e.g., controller 106 of FIG. 1A). The controller(s) then adjust the mode or settings of a mode of specific SS MW generators to produce a change in temperatures and/or heating patterns.

Again, some figures do not show subcomponents or design alternatives which are known and understood in the food processing industry. Bends can accommodate design production floor size constraints and use rollers, carousels, or curved conveyors. Inclines can be added to achieve greater hydrostatic pressure by lowering the heating zone relative to level of immersion liquid in other zones, and transport carriers can be conveyed up and down inclines by paddle belt or chain conveyors. Likewise, inclines can replace tray loader assemblies in the loading and unloading stacks. Loading and unloading can be manual or integrated within a larger plant. For example, separate machinery can be used to prepare and package food products, then feed transport carriers directly to the tray loader 401. Similarly, the unloading stack 408 may lead to automated boxing and warehousing equipment.

Though the overall system is continuous flow, with packages introduced at the beginning of the processing line and removed after processing, conveyance components are configurable to allow for transport carriers to remain stationary for temporary periods through the process. For example, users may reduce the size of a particular zone yet extend the time period of exposure to the immersion liquid within that zone. Similarly, rather than having packages move past multiple SS MW generator pairs to increase total heating energy, transport carriers may pause movement during exposure to a single pair or be moved back and forth (or side to side) past the same pair or pairs of SS MW generators multiple times. The resulting extended exposure, combined with steering and sweeping modes discussed further below, both increases total energy and ensures that packages are heated with greater uniformity (or preferential heating if desired).

Various circulation, control, heating, and heat exchange methods are usable for the immersion liquid, such as steam and electric resistive coils. Within the MW heating zone 404, MW generators may partially heat the immersion liquid (often water of low ionic conductivity produced from a reverse osmosis unit) along with the food product. SS MW generators or other types of heating elements may also be used to preheat or assist in preheating the immersion liquid before transport carriers are introduced and in the holding zone 405. As noted, the portals 403 and 406 are selected and configured to inhibit mixing between zones. These may include rubber flaps, doors, or other baffle mechanisms, or be replaced by lifting and lowering (e.g. by ramps) the transport carriers out of and into completely separate basins of immersion liquid.

The immersion liquid supplies a hydrostatic pressure that limits or prevents the water content of the items from rupturing the items while the MW energy is applied. Water is the immersion liquid of choice for many applications, and packages are dried after processing with simple blowers.

### Operating Modes

Even when used at a fixed frequency and fixed phase angle, SS MW generators provide benefits in comparison to magnetrons with respect to more stable output over a longer duty life at a lower operating voltage. In addition to a fixed output mode, programmable computer controllers are configurable to monitor and select frequency, phase, and amplitude of each SS MW generator, allowing for adjustment of MW energy in each cavity and between opposing cavities where some MW energy can be expected to travel through the immersion liquid and food items. This includes tuning relative phase and amplitude to synchronize paired or ringed generator arrays, as well as phase differences between transmitter elements within a single array. Different operating modes help account for differences between foods run on the same processing line, giving the system more flexibility to handle a variety of products. Software executed by exemplary controllers may also incorporate feedback controls using infrared, RF, or other sensors to drive actual MW outputs toward a desired result, as already discussed above.

For embodiments incorporating opposing SS MW generators in pairs above and below the MW heating zone, e.g. as in FIG. 2A, horizontal planes of maximum heating intensity are settable and adjustable vertically up or down by changing the relative phase and/or the relative amplitude (power ratio) of the paired generators. For purposes of discussing relative phase difference between paired generators, all elements within a SS MW generator array may be in phase with each other such that there is no beamforming or focusing effect as described further below, other than the expected lobing perpendicular to the transmitter array.

Paired generators transmitting in phase (0° phase difference) produce an anti-node (maximum strength constructive interference pattern) at the central plane half-way between the top and bottom generators. Anti-nodes shift away from the central plane as a phase difference is applied. At 180° phase difference, a node (maximum destructive interference pattern) forms at the central plane. Heating uniformity across the thickness of food packages can thus be adjusted using phase control from -180° to +180° between the paired generators. Dynamically adjusting the phase difference to sweep through the depth of food packages can help achieve better heating uniformity in homogeneous food products.

Food packages of different thicknesses within the same carrier or channel of immersion liquid may have different vertical offsets relative to the center plane. Adjusting the relative phase difference and/or power ratio between paired generators to move the “hot zone” toward or away from the central plane of the heating cavity provides flexibility with respect to different product runs using the same heating system. Without this capability, or dimensional changes to the equipment, thinner packages in the immersion liquid channel tend to overheat on either the top or bottom depending on the interference pattern, while the opposite side remains under-processed.

Steering or dynamically shifting MW patterns are techniques usable to improve heating uniformity as well as offer preferential heating inside food packages with different food components (with different dielectric properties) in layers or sections within a food package. Foods with different dielectric properties (related largely to salt content) have different capacities to absorb MW energy. The heating rate in food is inversely proportional to its specific heat capacity and proportional to its dielectric loss factor. This absorption of energy also relates to depth of penetration and is a consideration with respect to transmission through the immersion liquid and into food packages. Table 2 compares dielectric characteristics of tap water and deionized water at different temperatures and for different MW frequencies, showing lower absorption and greater transmission through deionized water. Charted characteristics include relative dielectric constant ε′, loss factor ε″, and penetration depth dₚ.

TABLE 2

Comparison of dielectric properties and penetration depths of MW energy at different temperatures for tap water and deionized water.

| T(°C) | Tap Water | | | | | | Reverse Osmosis (RO) Water | | | | | |
|---|---|---|---|---|---|---|---|---|---|---|---|---|
| | 915 MHz | | | 2450 MHz | | | 915 MHz | | | 2450 MHz | | |
| | ε′ | ε″ | dₚ (mm) | ε′ | ε″ | dₚ(mm) | ε′ | ε″ | d ₚ(mm) | ε′ | ε″ | dₚ (mm) |
| 20 | 79 | 4.4 | 107.0 | 78 | 9.9 | 18.0 | 79 | 3.5 | 131.0 | 78 | 9.3 | 19.0 |
| 80 | 62 | 2.8 | 148.0 | 63 | 2.5 | 61.0 | 62 | 1.1 | 369.0 | 62 | 2.4 | 63.0 |
| 120 | 52 | 3.1 | 122.0 | 53 | 1.6 | 86.0 | 52 | 0.8 | 457.0 | 53 | 1.2 | 117.0 |

Example foods, such as salmon fillets and cooked pasta, have lower dₚ, absorbing substantially more energy than water. Because meal components with higher salt content have a higher loss factor, it is often preferable to steer more energy to portions with a lower salt content. If a food package containing two layers of food with different dielectric properties (e.g., salty sauce on top of low-salt salmon fillet or sauce on top of rice) is heated in the heating cavity with same MW energy (with no phase difference) supplied from both the top and the bottom ports of the cavity, the temperature of the top and bottom layers of the food will increase differently when exposed to the same MW field intensity. To obtain uniform heating within the food packages or preferential heating in top or bottom layer that requires more heating, the phase difference and power ratio between the two generators is adjustable to make the “high microwave field intensity zone” shift and better align with the slower-heating layer or the layer requiring more heating inside the food package. A determination of which layer of an item requires more heating may be performed prior to the heating process based on an analysis of the item in question and/or during the heating process using sensors providing feedback of heating patterns within the item.

Shifting the “high microwave field intensity zone” is achievable through adjustment of the power ratio as well as phase difference between outputs from paired generators. This power ratio strategy may be particularly useful for improving uniform heating inside the packages containing different food components with different dielectric properties and specific heat capacities in top and bottom layers, or for preferential heating to the top or bottom layer in a food package.

Beyond modes related to differential power and phase shift between paired generators, SS MW generators are in some embodiments formed from phased arrays of transmitter elements. These phased arrays are capable of steering and focusing an energy lobe. In the paired configuration of FIG. 2A, phased arrays may be preferred for both the top SS MW generator 201 and the bottom SS MW generator 203, and each array is able to independently steer energy along and laterally across the processing line.

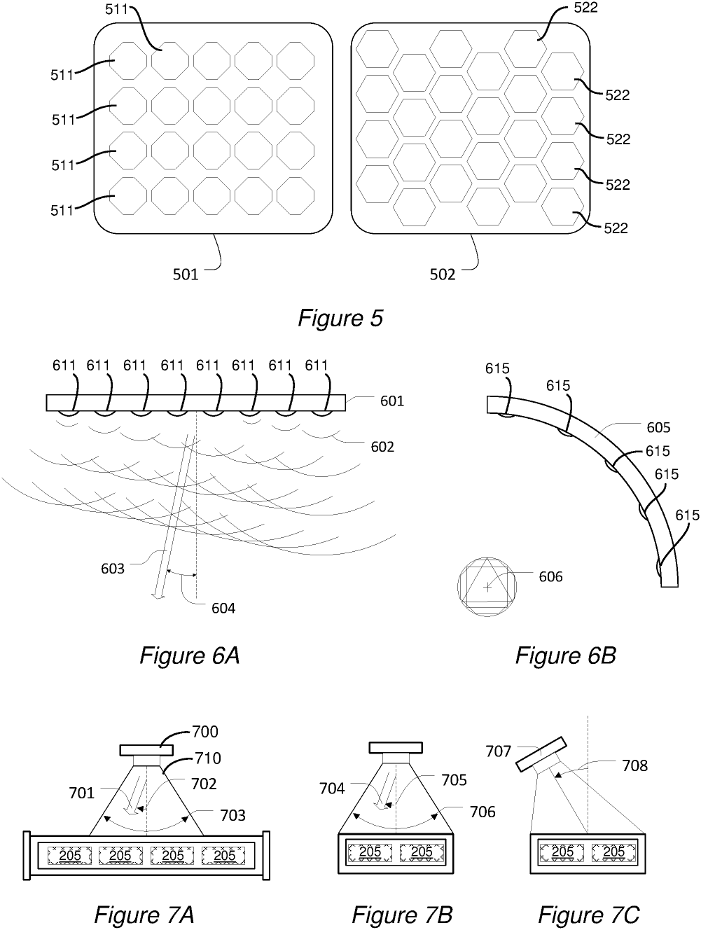

FIG. 5 illustrates two alternate SS MW phased arrays with primary transmission path perpendicular to the surface plane: an orthogonal arrangement 501 of transmitter elements 511 and a hexagonal pattern 502 of transmitter elements 522. Regardless of the array geometry, individual elements are describable in terms of orthogonal component vectors and controllable for steering effects.

FIG. 6A shows beamforming with a sideview of an example array 601, where MW wave peaks emanating from individual transmitter elements 611 are illustrated by arcs 602. If no phase shift is applied between the array’s transmitter elements, the main energy lobe radiates perpendicular to the array surface. Linear phase shifting between successive transmitter elements of the array effectively forms a wave direction 603 which is offset from perpendicular by a beam or lobe angle 604. Digital controllers (e.g. controller 106 in FIG. 1A) are usable to hold a steady beam angle or dynamically alter the phase shift to sweep the beam. Non-linear phase shifting is usable to produce a focus point rather than beam.

FIG. 6B illustrates a simpler solution where single point focus is desired: a curved array 605 of transmitter elements 615 with natural focal point 606. Phase shifting elements within the curved array are capable of pushing focus toward or away from the array surface. Curved surface phased arrays are usable in various applications and are well suited to those with a clear focus point, such as where food product is piped through the heating section or conveyed in a transport carrier with a near-equilateral cross section. This suits applications where it is desirable to package food in cylindrical containers.

FIG. 7A presents a side view of a single MW array 700 and cavity 710 on top of a section of a food processing line, where food packages 205 are conveyed left to right. MW energy 701 is directed at a beam angle 702, or swept through a range of angles 703 along the processing line. This view can be considered to illustrate the x component of energy displacement.

FIG. 7B provides a cross-section of the processing line, with food packages 105 traveling perpendicular to the surface (into the page). MW energy 704 is directed at a beam angle 705, or swept through a range of angles 706 laterally across the processing line. This view can be considered to illustrate the y component of energy displacement.

FIG. 7C shows arrangement of a single MW array 707 with an offset angle 708 from the processing line centerline. An offset provides flexibility in design where other considerations such as wiring or visual inspection are paramount, and may be used in applications where there is more than a single pair of MW generators. Though uniformity of heating is usually a key goal in food processing systems, some food products may be packaged such that they require asymmetrical heating energy (e.g., separate compartments for rice and sauce). Offsetting a generator as in FIG. 7C provides a simple method of accomplishing that, though SS MW phased arrays allow operators to select uniformity for one product run and asymmetry for the next, by steering and sweeping MW energy. This preferential heating compares to that described above for layered foods, except that here components are separated laterally either within a single packaging compartment, or within separate compartments of a packaged meal.

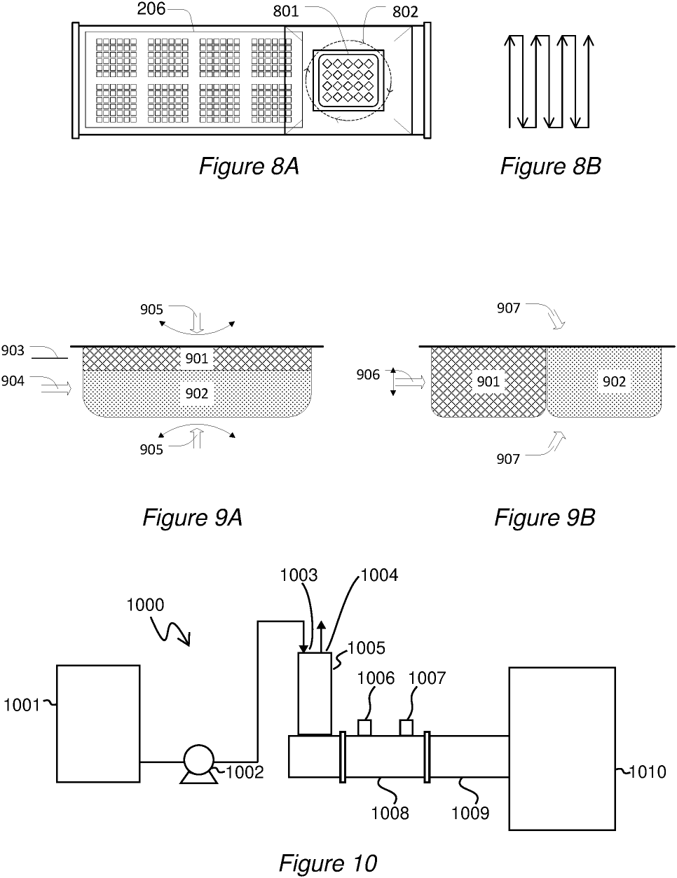

FIG. 8A shows a top view of a section of processing line with food transport carrier 206 conveyed left to right, approaching and starting to pass under a MW array assembly 801. Because transmitter elements are arrayed both along and across the direction of travel of food packages, an example circular sweep pattern 802 combines both an x component oriented along the processing line, and a y component across the processing line.

FIG. 8B further illustrates a simple progressive scan pattern. Sweeping patterns can be controlled for rate of sweep and coordinated with the motion and position of transport carriers. Likewise, the rate of conveyance is alterable to increase or decrease exposure of transport carriers to MW energy and the conductive heating and cooling of immersion liquid within each temperature control zone. Also, as described above, the transport carrier is capable of being paused or temporarily reversed within the overall conveyance scheme such that energy may be focused or swept across packages for an extended period settable to various durations of time.

FIGS. 9A and 9B show two food packages in side view, illustrating exemplary heating options and modes. FIG. 9A depicts layered foods, wherein a salty product 901 is layered above a lower salt product 902. That is to say, layer 901 is saltier than layer 902. A central plane between paired top and bottom SS MW generators is depicted with line 903 and the “hot zone” heating plane 904 is offset from this, both to account for the food package having a different central plane, and to provide more energy to the product with slower heating characteristics. While maintaining a phase differential and/or power ratio between paired generator arrays, energy lobes 905 can be swept laterally across the package. Alternately, the horizontal heating plane can be swept up and down so long as the cumulative energy is concentrated on the bias or offset plane.

FIG. 9B illustrates preferential heating for laterally heterogeneous products which can be in separate package sections. As in FIG. 9A, product 902 is less salty than product 901. In this case the heating plane 906 can be swept up and down, while phased arrays steer energy lobes 907 toward the product with slower dielectric heating characteristics. The array lobes may also be dynamically swept around an offset angle.

Whereas kitchen-scale MW ovens typically use MWs in the 2-3 GHz band, 915 MHz is preferred for some exemplary embodiments used in industrial food processing applications, as the longer wavelength energy results in deeper heating penetration inside food products and the channel of immersion liquid. Longer wavelengths may not always be optimal, such as in applications wherein operators desire to process thinner packaged portions within a lower-capacity channel of immersion liquid, or preferential surface heating is desired. In those cases, higher frequency MW generators can be more effective in ensuring energy absorption. To provide flexibility, some industrial systems may be built with some SS MW generators capable of and set to a lower frequency band and other generators at a higher frequency band. Embodiments herein include single and multiple SS MW generators at a common center frequency, as well as multiple generators configured to apply various frequency bands at different points along the processing line.

Calibration packages with known heating profiles (e.g., specific gelatin formulas) may be processed for purposes of calibration, using embedded instrumentation, real-time surface imaging (e.g., infrared) or post-processing measurements (e.g., probes, infrared).

Although the description herein contains many details, these should not be construed as limiting the scope of the disclosure but as merely providing illustrations of some exemplary embodiments. Therefor the scope of the disclosure encompasses other embodiments which may become obvious to those skilled in the art.

SS MW generators and control systems according to this disclosure may be used in applications other than commercial sterilization or pasteurization. For example, exemplary embodiments may include SS MW generators configured for other industrial MW heating purposes, such as thawing, tempering, drying, and baking, along with food service and domestic MW heating/cooking in the USA and worldwide.

In the claims below, reference to an element in the singular is not intended to mean “one and only one” unless explicitly stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element is to be construed as a “means plus function” element unless the element is expressly recited using the phrase “means for . . . .”. No claim element is to be construed as a “step plus function” element unless the element is expressly recited using the phrase “step for . . . .”.

In the description herein, a word appearing in the singular encompasses its plural counterpart, and a word appearing in the plural encompasses its singular counterpart, unless implicitly or explicitly understood or stated otherwise. Furthermore, it is understood that for any given component or embodiment, any of the possible candidates or alternatives listed for that component may generally be used individually or in combination with one another, unless implicitly or explicitly understood or stated otherwise. Moreover, the figures are not necessarily drawn to scale, wherein some of the elements may be drawn merely for clarity. Also, reference numerals may be repeated among the various figures to show corresponding or analogous elements. Additionally, any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Various embodiments of processing systems, components, and compositions for sterilization or pasteurization and associated methods of operation are described herein. In the above description, specific details of systems, components, and operations are included to provide a thorough understanding of certain embodiments of the disclosed technology. A person skilled in the relevant art will also understand that the technology may have additional embodiments. The technology may also be practiced without several of the details of the embodiments described herein.

### Example 1

This Example illustrates how to analyze the performance of SS 915-MHz MW generators, including generator calibration, energy efficiency, and power, frequency & phase control stability.

Experience indicates that the overall power of 3-6 kW supplied to a 915-MHz single-mode MW heating cavity is better suited for relatively uniform heating than higher power. A lower-power SS generator with fewer power amplifiers/modules has a higher efficiency and a smaller size than a higher-power generator. Therefore, 6-kW SS generator systems is selected for this Example. A SS generator supplier, RFHIC Corp., is a suitable source for SS 915-MHz generator systems. A 6-kW SS 915-MHz generator system (consisting of two 3-kW generator heads and a control box) acquired from RFHIC Corp. is tested with MW power calibration units according to FIG. 10 for power calibration, energy efficiency determination, power stability, power ratio controllability, and frequency & phase control stability studies. A MW power calibration/testing unit 1000 comprises a water load 1005 (Ferrite MW Technologies, Nashua, NH), a water tank 1001, a progressive cavity pump 1002 for running water through the water load 1005, and two RTD temperature sensors for water temperature measurement near the inlet and outlet of the water load. FIG. 10 shows a water inlet 1003, a water outlet 1004, a reflected MW power sensor 1006, and a forward MW power sensor 1007. FIG. 10 also includes a directional coupler 1008, a waveguide 1009, and a MW generator head 1010. Two generator heads are tested at the same time with two MW power calibration/testing units. In calibration, a water load converts over 99% MW energy from each of the two MW generator heads into thermal energy so that the power output (P, in kW) of the two generator heads is calorimetrically determined based on the difference of the water temperatures (Tₒᵤₜ, Tᵢₙ) measured at the outlet and inlet of the water load and the flow rate (Q, in kg/s) of the water running through the water load using the following equation:

$$P = \text{CpQ} \left({T}_{o u t} - {T}_{i n}\right)$$

where Cp is specific heat of water (e.g. 4.18 kJ/(kg·K)). The measured power outputs corresponding to different power setting levels over the full range of the power capacity (i.e., 0-3 kW) are used to calibrate the MW generator heads and the directional coupler (a MW power measurement device) placed in the waveguide between the generator heads and the water loads. The peak MW frequencies is measured using a TM-2650 spectrum analyzer and an AN-301 antenna (B&K Precision, Yorba Linda, CA). The phases of the two MW power heads will be determined using an MSO-X 4154A oscilloscope (Keysight Technologies, Santa Rosa, CA) connected to the directional couplers through RF cables.

The electric power supplied to the generator system is measured by a Fluke 1735 three-phase power logger (Fluke Corp., Everett, WA USA). The efficiency of the generator system is determined based on the input utility power measured by the Fluke power logger and the output MW power of the two generator heads measured by the water load using the following equation:

Generator system efficiency = (output MW power / input utility power) *100%

The supplied utility electric powers to the generator system and the MW power outputs the peak frequencies, and the phase difference at each of the selected conditions (e.g., power settings: 1, 2, & 3 kW, frequency settings: 902, 915, & 928 MHz, and phase deference settings: 0, 90, & 180°) of the two SS generator heads are continuously measured for over 4 hours, twice a month during a period of 5 months, to determine the stability of MW power outputs, peak frequency, phase control, and overall energy efficiency of the SS generator system. In addition, the output powers of the two generator heads are measured at different power ratio settings (e.g., 1:1, 1:1.5, and 1:2, with maximum power of 3 kW) to study the power ratio controllability.

Power, frequency, and phase testing data from the above-described setup are usable to determine the stability, reliability and energy efficiency of 915 MHz SS generators.

### Example 2

This Example illustrates how to develop a single-mode 915-MHz MW heating test unit with one MW heating applicator/cavity powered by SS MW generators.

A single-mode MW heating applicator powered by a 6-kW SS 915-MHz MW generator system (with two 3-kW generator heads) is built to study the enhanced performance due to the unique features (described above) of SS MW generators. The applicator consists of: 1) a single-mode heating cavity, 2) two horn-shape waveguides connected to the cavity from the top and bottom with a MW-transparent polyetherimide (Ultem) plate (window) placed between the heating cavity and the horn-shaped waveguide. After calibration for Example 1, one of the SS generator heads is mounted to the top and another to the bottom of the horn shaped waveguides. The resulting configuration corresponds with FIG. 2A. The two generator heads provide a combined MW power of up to 6 kW.

A control system controls the overall power and the relative power ratio between the top and bottom generator heads, as well as the phase difference & peak frequency. In experiments, food packages (trays or pouches) on a food carrier are heated by the combination of MW energy and circulating hot water. The food carrier utilizes selected metal mesh covers designed to improve the food heating uniformity. The water is supplied from a reverse osmosis (RO) system that removes most of the ions from tap water. The RO water temperature is closely controlled by a circulation system with external heat exchangers for adding or removing heat. At 915 MHz, the MW power penetration depth in RO water is large (as shown in Table 1), and little MW energy is absorbed by the RO water at the elevated temperatures used in pasteurization and sterilization of foods, yet the circulating water eliminates edge heating of the food packages and improves heating uniformity. Industrial size RO systems are inexpensive. They are readily available from commercial suppliers and are easily added to industrial pasteurization and sterilization systems.

The SS 915-MHz generator heads are equipped to synchronize phases and control phase difference between their MW output ports which are connected to the applicator cavity. Each generator head has remote control and monitoring capability for operating the equipment and collecting data for the various experimental powers phases and frequencies selected.

The above developed single-mode 915-MHz cavity with two SS MW generator heads is directly added to a system matching the configuration shown in FIG. 4, except that the heating zone 404 includes only one pair of SS MW generator heads, not four pairs as shown in FIG. 4. This unit comprises a pre-heating (loading), MW heating, holding and cooling (un-loading) sections. The water temperatures in preheating, heating & holding, and cooling sections are controlled by the heat exchangers in each of the water circulation loops. In a test, multiple food packages in a carrier are loaded into the preheating section where they are heated to a certain equilibrium temperature (e.g., 40° C.). The food packages are moved into the MW heating cavity in which the carrier is either positioned stationary in the center of the cavity, moved through the heating cavity, or swept back and forth between locations to either side of the heating zone 404 in FIG. 4 to emulate heating with multiple cavities so that the cold spot in food packages will reach a pasteurization temperature (e.g., 90° C.). They are then moved to the holding section (zone 405) for a predetermined time duration before moving into the cooling section 407.

Performance tests on the SS MW power control are made to ensure that all the power parameters (power level, frequency, and phase) can be functionally controlled and monitored. Peak frequencies are measured by a TM-2650 spectrum analyzer and an AN-301 antenna (B&K Precision, Yorba Linda, CA). The phases of the two MW power heads will be determined using an MSO-X 4154A oscilloscope (Keysight Technologies, Santa Rosa, CA) connected to the directional couplers through RF cables. MW power are measured by calibrated directional couplers or determined with the MW-power calibration/testing system of FIG. 10.

Example 2 yields a functional 915-MHz single-mode MW heating applicator (heating cavity) powered by two synchronized SS MW generator heads with controllable and adjustable MW power parameters (power, phase, and frequency) for heating uniformity and variable heating rates.

### Example 3

This Example illustrates how to analyze performance of 915-MHz MW heating using combined power from two synchronized SS generator heads. In particular, this Example discusses phase control between at least two SS generator heads.

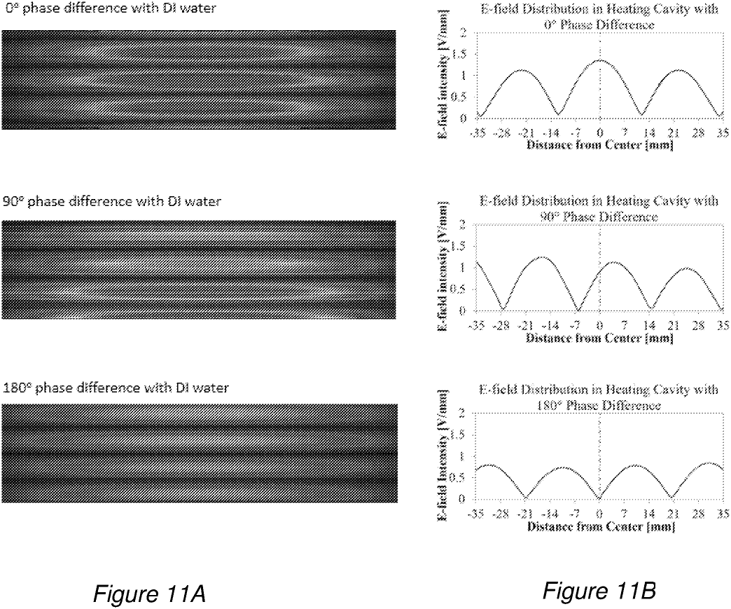

First, the influence of phase differences (or phase shifts) between two MW generator heads on the MW heating in a single-mode 915-MHz MW heating applicator is investigated using computer simulation. The simulation results for the different phase shifts (0°, 90°, and 180° phase difference) between the MW sources supplied to the MW heating applicator ports (top and bottom) are shown in FIGS. 11A and 11B. The phase difference was defined as the phase of the MWs supplied to the top port of the heating cavity minus that of the MWs to the bottom port. An anti-node (maximum strength) and a node (minimum strength) were observed on the central plane of the MW heating cavity (where food packages are located) for 0° and 180° phase difference, respectively. For a 90° phase difference (90 more degrees in the phase of the power to the top port than that of the power to the bottom port), neither node nor anti-node was formed in the middle locations. The simulation results suggest that the electric field intensity at the central plane of the MW heating cavity is capable of being varied between the maximum (anti-node) and the minimum (node) with proper phase difference adjustments. Heating uniformity along the thickness of the food packages may also be adjusted using the phase control between the two MW generator heads that launch MWs from the top and bottom ports of the cavity. These results may be obtained experimentally using a 915 MHz MW heating applicator with the two SS generator heads. However, a magnetron-based MW generator lacks a comparable ability for phase control.

Using a system as in FIG. 4, except that the heating zone 404 includes only one pair of SS MW generator heads, it is possible to test the relative MW phase (-180 to 180° difference) of the outputs from the two SS MW generator heads. Following are three exemplary setups and tests. Experimental data shows enhanced heating performances using unique features of the SS MW generators. Improved heating pattern, heating uniformity, and heating rate inside food packages are obtained by controlling and optimizing the SS power parameters (phase & frequency control, power level, power ratio (Example 4)).

Example 3A. Dynamically adjusting the phase difference to sweep the hot and cold zones to achieve better heating uniformity in homogeneous food along the depth of the food packages in the heating cavity. Model foods (e.g. mashed potato gel) with selected salt levels (e.g., 0.1, 0.5, 1.0 or 1.5%) packaged in trays and pouches are tested in the single-mode 915 MHz heating cavity. 1.5% represents the salt level for high-salty food, while 0.1% for low-salty food. After preheating, the food packages on a metal carrier are moved into the MW heating cavity shown in FIG. 4 (except that the heating zone 404 includes only one pair of SS MW generator heads) and held there for a selected time period (e.g., 3 or 4 min), or continually moved through the heating cavity with a selected speed, or swept back and forth between locations to either side of region 404 to emulate multi-cavity heating. The same power from the two generator heads (e.g., 3 kW & 3 kW) is supplied from the top and bottom ports of the cavity while the phase difference is controlled to vary repeatedly within the range of -180 to 180°. After heating, the food packages are moved into the cooling section for cooling down and unloading. A chemical-marker based computer-vision method (described in the following paragraph) is used to evaluate heating pattern and heating uniformity. The temperatures at cold/hot spots inside food packages are measured by wireless miniature temperature sensors (TMI-USA, Inc, Reston, VA). For comparison, tests with no phase difference (0° phase difference) may also be conducted.

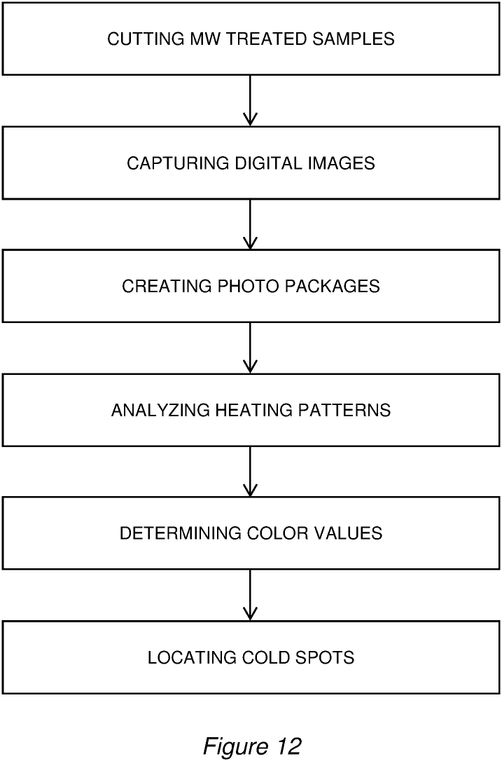

For the above tests, the model food (mashed potato gel) is made from several ingredients including gellan gum 1%, potato flakes 3%, fructose 2%, L-lysine 1%, calcium chloride 0.15%, titanium dioxide liquid 0.4%, salt 0 -1.5%, and DI water. Gellan gum & calcium chloride are used for solidifying the model food sample, titanium dioxide liquid is a lighter color addition, and fructose & L-lysine are the chemical marker precursors. During a thermal processing at pasteurization temperatures (e.g., between 70-90° C.), chemical marker M2 is formed in the Maillard browning reaction between reducing sugar (fructose) and amino acid (L-lysine) in the model food sample. The brown color change in the model food is detected using a computer-vision method (shown in FIG. 12). The heating patterns as reflected by the color change in both the horizontal and the vertical planes inside the model food samples are obtained. The color scale (range of color value) of 0 - 255 will be used for defining the color values in the heating pattern image. Blue color will have the value of 0, red color the value of 255, and green or yellow color the value between 0 and 255. The color distribution will show the heating uniformity inside the food package. The standard deviation of the color values and the color-value difference between the hot and cold spots are used as the indicator for heating uniformity; the smaller the color value deviation and difference, the more uniform the heating is. The heating uniformity along the depth direction inside the food package may be sharply improved by dynamic changing phase difference between the power outputs of the two generator heads. The resulting advantages in industrial systems are reduced heating time, increased throughputs, and improved food quality.

Example 3B. Adjusting the phase difference (between the two MW generator heads) to align the “hot zone” with the middle layer of the food packages which is not exactly located at the central plane of the heating cavity. Model food samples with different thickness (e.g., 16, 20, 24, 30 mm) and various selected phase differences (e.g., 0, ±30, ±60, ..., ±150, and 180°) will be tested using the system shown in FIG. 4, except that the heating zone 404 includes only one pair of SS MW generator heads. 16 mm is the thickness of the model food sample filled in standard 7-oz trays or 8-oz pouches, and 30 mm is the maximum thickness of the sample filled in standard 10.5-oz trays. The samples with different thicknesses sitting on the same carrier have different vertical offsets relative to the center plane in the cavity, so it is desirable to adjust the heating pattern accordingly by using phase control. For example, as shown in FIGS. 11A and 11B, a 90° phase difference should make the “hot zone” moving downwards below the central plane of the cavity. A negative 90° phase shift should make the “hot zone” moving upwards above the central plane. Selection of positive or negative phase difference for testing depends on the relative position of the food sample (in the cavity) determined by the sample thickness. All the tests are performed with an identical food package carrier and with the same MW powers (e.g., 3 & 3 kW) supplied from the two generator heads to the top and bottom ports of the cavity. MW processing of samples, temperature measurement, and heating pattern analysis are performed in the same way as described in Example 3A. The test results show how phase difference influences MW heating of foods in different package thickness in terms of heating rate in the middle layer. From the procedures of this Example, phase control strategies may be developed for industrial implementation so that commercial systems are able to process foods in a wide range of package thicknesses without the need to physically modify the carrier or the carrier transport positions.

Example 3C. Adjusting the phase difference to improve uniform heating inside food packages with different food components (with different dielectric properties) on top and bottom layers within the food package. Foods with different dielectric properties have different capacities to absorb MW energy. If a food package containing two layers of food with different dielectric properties (e.g., high-salty sauce on top of low-salty salmon fillet or sauce on top of rice) is heated in the heating cavity with same MW power (with no phase difference) supplied from both the top and the bottom ports of the cavity, the temperature of the top and bottom layers of the food will increase differently. To obtain uniform heating within the food packages, phase difference between the two powers can be adjusted to align the “hot zone” with the slower-heating layer inside the food packages. 10.5-oz trays filled with two layers (top and bottom layers, 300 g, 24 mm thickness) of the model food with different salt contents (e.g., 0.5% & 0.1% - small difference, 1% & 0.1% - medium difference, or 1.5% & 0.1% - large difference) are used for testing using various phase differences and with a selected MW power (e.g., 3 kW from each of the two generator heads) supplied to both the top and the bottom ports of the heating cavity. The salt content range of 0.1% to 1.5% covers the salt levels for most of the foods, from low-salty to high-salty foods. The heating rate in food is proportional to the value of its dielectric loss factor and inversely proportional to its specific heat capacity. High salt content components have a higher loss factor, therefore proper phase shift is selected to place the “hot zone” in the layer that has a lower salt level and high specific heat. The heating test procedure is the same as that used in Example 3A. The heating pattern, heating uniformity, and temperatures inside the food packages are measured in the same way as described in Example 3A. Heating-rate tests are also conducted on selected real foods, such as pre-packaged salmon/Alfredo sauce or rice/sauce & meat, with different phase shifts. Dielectric properties of model food and food components are determined using a Model-4291B impedance/material analyzer with probe (Hewlett Packard Corp., Santa Clara, CA). Specific heat capacities of the foods are determined using the KD2-Pro thermal property analyzer (Meter Inc., Pullman, WA). Testing results of this Example present optimized phase differences between the two generator heads for MW heating of the food package containing two layers of food with different salt contents (or dielectric properties) or specific heat capacities. The results provide a better understanding of how the phase difference can be used to improve heating uniformity and perform preferential heating inside the food packages with different food components in top and bottom layers.

### Example 4

This Example illustrates further analysis of performance of 915-MHz MW heating using combined power from two synchronized SS generator heads. In particular, this Example discusses power-ratio control between at least two SS generator heads.

Similar to the shift of “hot zone” controlled by phase difference as described above, the shift of “hot zone” can also be accomplished by adjustment of the ratio of the power outputs from the two (or more) generator heads. This strategy may be particularly useful for improving uniform heating inside the packages containing different food components with different dielectric properties and specific heat capacities in top and bottom layers, or for preferential heating to the top or bottom layer in a food package. Similar to the tests described in Example 3C, two layers of model food with different salt contents (e.g., 0.5% & 0.1% - small difference, 1% & 0.1% - medium difference, 1.5% & 0.1% - large difference) in the same package and selected real food, such as pre-packaged salmon/Alfredo sauce or rice/sauce & meat, are tested with various power ratios of the powers supplied to the top and bottom ports of the heating cavity (e.g., 1:1, 1:1.5, and 1:2, with maximum power of 3 kW) for each pair of salt contents and with no phase difference between the two generator heads. A proper power ratio is selected to ensure uniform temperature increases in both layers of the samples. Test results present optimized power ratios for MW heating of the food package containing two layers of food with different salt contents (dielectric properties) or specific heat capacities. Test results show that adjustment of the power ratio is another effective strategy for improving heating uniformity inside the food packages with different food components in top and bottom layers or for performing preferential heating to the top or bottom layer of food, whichever needs more heating.

What is claimed is:

1. A method of sterilization or pasteurization of an item of packaged food, the method comprising:
conveying the item through an immersion liquid, the immersed item being subject to heat conduction to or from the immersion liquid;
applying microwave (MW) energy from one or more solid-state (SS) MW generators to the item while the item is conveyed through the immersion liquid;
controlling the one or more SS MW generators to achieve a desired uniformity of heating within the item by changing one or more of amplitude, frequency, and phase of the MW energy from at least one of the one or more SS MW generators; and
wherein the applying and controlling steps heat the item immersed in the immersion liquid to a temperature sufficient to achieve sterilization or pasteurization of the item.

2. The method of claim 1, wherein the controlling step comprises tuning and/or dynamically shifting one or more of amplitude, frequency, and phase of the at least one of the one or more SS MW generators.

3. The method of claim 1, wherein the one or more SS MW generators include at least one pair of SS MW generators which apply MW energy from opposing sides of the item.

4. The method of claim 3, wherein controlling the at least one pair of SS MW generators comprises, via a first mode, setting a plane of maximum MW energy intensity between the pair of SS MW generators by changing one or more of the relative amplitude and relative phase shift of the output MW energy from the at least one pair of SS MW generators.

5. The method of claim 1, wherein the one or more SS MW generators include one or more SS MW generators configured as a phased array of a plurality of transmitter elements.

6. The method of claim 5, wherein controlling the one or more SS MW generators configured as a phased array includes one or more of: via a first mode, setting a MW energy main lobe direction from each phased array; and, via a second mode, sweeping the MW energy main lobe along and/or across a direction in which the item is conveyed through the immersion liquid.

7. The method of claim 1, further comprising: maintaining the item at a holding temperature for a period of time sufficient to achieve sterilization or pasteurization of the item.

8. The method of claim 1, further comprising: controlling the immersion liquid in one or more zones to maintain one or more desired zone temperatures.

9. The method of claim 8, wherein the one or more zones include a holding zone in which the immersion liquid is maintained at a holding temperature.

10. The method of claim 9, wherein the one or more zones include a cooling zone in which the immersion liquid is maintained at a cooling zone temperature lower than the holding temperature.

11. A processing system for sterilization or pasteurization of items having a water content, the processing system comprising:
a preheating section configured to preheat the items to a preheating temperature with an immersion liquid;
a heating section coupled to the preheating section, the heating section comprising a heating chamber coupled to one or more solid-state (SS) microwave (MW) generators, the heating section being configured to receive the items from the preheating section and to apply MW energy from the one or more SS MW generators to the items while the items are conveyed through the immersion liquid and subject to a hydrostatic pressure of the immersion liquid, wherein the hydrostatic pressure of the immersion liquid prevents the water content of the items from rupturing the items while the MW energy is applied; and
a computer controller coupled to the one or more SS MW generators, the computer controller being configured to change one or more of the amplitude, frequency, and phase of the MW energy from at least one of the one or more SS MW generators.

12. The processing system of claim 11, wherein the computer controller is further configured to tune and/or dynamically shift one or more of amplitude, frequency, and phase of the at least one of the one or more SS MW generators.

13. The processing system of claim 11, wherein the one or more SS MW generators include at least one pair of SS MW generators which apply MW energy from opposing sides of the item, wherein the computer controller is configured to, via a first mode, set a plane of maximum MW energy intensity between the pair of SS MW generators by changing one or more of the relative amplitude and relative phase shift of the output MW energy from the at least one pair of SS MW generators.

14. The processing system of claim 11, wherein the one or more SS MW generators include one or more SS MW generators configured as a phased array of a plurality of transmitter elements.

15. The processing system of claim 14, wherein the computer controller is configured to: via a first mode, set a MW energy main lobe direction from each phased array; and, via a second mode, sweep the MW energy main lobe along and/or across a direction in which the item is conveyed through the immersion liquid.

16. An apparatus for sterilization or pasteurization of items having a water content, the apparatus comprising:
a carrier housing having a channel extending between a first end and second end, and between a top and bottom, and between a first side and a second side, the carrier housing having one or more windows at one or more of the top, bottom, first side, and second side of the carrier housing, the windows being transmissive to microwave (MW) energy, wherein the carrier housing further includes an inlet and an outlet configured to allow an immersion liquid to circulate in the channel of the carrier housing;
one or more MW assemblies coupled to the one or more windows of the carrier housing, the one or more MW assemblies comprising one or more solid-state (SS) MW generators, and being configured to apply MW energy to the items while the items are conveyed through the immersion liquid and subject to a hydrostatic pressure of the immersion liquid, wherein the hydrostatic pressure of the immersion liquid prevents the water content of the items from rupturing the items while the MW energy is applied; and
a computer controller coupled to the one or more SS MW generators, the computer controller being configured to change one or more of the amplitude, frequency, and phase of the MW energy from at least one of the one or more SS MW generators.

17. The apparatus of claim 16, wherein the computer controller is further configured to tune and/or dynamically shift one or more of amplitude, frequency, and phase of the at least one of the one or more SS MW generators.

18. The apparatus of claim 16, wherein the one or more SS MW generators include at least one pair of SS MW generators which apply MW energy from opposing sides of the item, wherein the computer controller is configured to, via a first mode, set a plane of maximum MW energy intensity between the pair of SS MW generators by changing one or more of the relative amplitude and relative phase shift of the output MW energy from the at least one pair of SS MW generators.

19. The apparatus of claim 16, wherein the one or more SS MW generators include one or more SS MW generators configured as a phased array of a plurality of transmitter elements.

20. The apparatus of claim 19, wherein the computer controller is configured to: via a first mode, set a MW energy main lobe direction from each phased array; and, via a second mode, sweep the MW energy main lobe along and/or across a direction in which the item is conveyed through the immersion liquid.

21. A method of sterilization or pasteurization of one or more items of packaged food, the method comprising:
heating the one or more items with microwave (MW) energy from two or more solid-state (SS) MW generators to a temperature sufficient to achieve sterilization or pasteurization of the item; and
changing one or more of relative amplitude, relative frequency, and relative phase among the two or more SS MW generators to achieve a desired uniformity of heating within the one or more items.

22. The method of claim 21, wherein the changing step is based on feedback from one or more sensors configured to actively monitor temperatures and/or heating patterns in the one or more items as the one or more items are heated.

23. The method of claim 21, wherein the two or more SS MW generators include at least one pair of SS MW generators which apply MW energy from opposing sides of the item, wherein the changing step comprises setting a plane of maximum MW energy intensity between the pair of SS MW generators by changing one or more of the relative amplitude and relative phase shift of the output MW energy from the at least one pair of SS MW generators.
